(19) United States
(12) Patent Application Publication
(10) Pub. No.: US 2016/0056717 A1
(43) Pub. Date: Feb. 25, 2016

(54) POWER SUPPLY STABILIZING CIRCUIT AND PHOTODETECTOR USING THE SAME

(71) Applicant: KABUSHIKI KAISHA TOSHIBA, Tokyo (JP)

(72) Inventors: Hiroshi OTA, Misato Saitama (JP); Shunsuke KIMURA, Kawasaki Kanagawa (JP); Daigo SUZUKI, Kawasaki Kanagawa (JP); Rei HASEGAWA, Yokohama Kanagawa (JP)

(21) Appl. No.: 14/635,986

(22) Filed: Mar. 2, 2015

(30) Foreign Application Priority Data
Aug. 25, 2014 (JP) 2014-170552

(51) Int. Cl. H02M 3/156; G01J 1/44

(52) U.S. Cl. CPC H02M 3/156; G01J 1/44

(57) ABSTRACT

A power supply stabilizing circuit includes a diode having a cathode connected to an output terminal of a direct current power circuit configured to generate a direct current voltage and to supply the voltage therefrom to a load circuit, and a capacitor connected to an anode of the diode. The power supply stabilizing circuit may further include a transistor having a first terminal connected to the output terminal of the direct current power circuit, a second terminal connected to a connection node between the diode and the capacitor, and a switching electrode connected to the connection node.

### CROSS-REFERENCE TO RELATED APPLICATION

This application is based upon and claims the benefit of priority from Japanese Patent Application No. 2014-170552, filed Aug. 25, 2014, the entire contents of which are incorporated herein by reference.

### FIELD

Embodiments described herein relate generally to a power supply stabilizing technique.

### BACKGROUND

In an X-ray computed tomography (CT) apparatus, a silicon photomultiplier (Si-PM) is used as a sensor, where the Si-PM includes Si photodiode arrays using a plurality of avalanche photodiodes (hereinafter, referred to as APD), which are a type of Si photodiode. Such a Si-PM detects visible light or ultraviolet light into which a scintillator converts from X-ray energy. The Si-PM detects an amount of radiation light in a so-called Geiger mode, in which the photodiodes are operated according to a reverse voltage exceeding the breakdown voltage of the photodiodes. Therefore, when a power supply voltage to the Si-PM fluctuates, a detection signal for the amount of radiation light may fluctuate even when the amount of radiation light does not change. As a result, precise detection of the amount of radiation light may not be carried out.

### DESCRIPTION OF THE DRAWINGS

FIG. 1 is a chart illustrating current to voltage characteristics in a single Si photodiode.

FIG. 2 is a circuit diagram illustrating a power supply stabilizing circuit according to a first embodiment and a Si-PM connected thereto.

FIG. 3 is a waveform chart illustrating the operation of the circuit of FIG. 2.

FIG. 4 is a waveform chart illustrating a stabilizing operation in a DC/DC converter.

FIG. 5 is a circuit diagram illustrating a power supply stabilizing circuit according to a second embodiment and a Si-PM connected thereto.

FIG. 6 is a waveform chart illustrating the operation of the circuit of FIG. 5.

### DETAILED DESCRIPTION

In general, according to one embodiment, a technique for stabilizing a power supply voltage, and a photodetector using the technique, is provided.

According to one embodiment, a power supply stabilizing circuit includes a diode having a cathode connected to an output terminal of a direct current power circuit configured to generate a direct current voltage and to supply the voltage therefrom to a load circuit, and a capacitor connected to an anode of the diode.

Hereinafter, embodiments will be described with reference to the drawings.

The Si-PM is formed by a plurality of Si photodiodes arranged in an array. Each Si photodiode forming the Si-PM converts photons from a scintillator into photoelectrons at a high speed. Because the Si-PM uses a plurality of Si photodiodes, the Si-PM varies largely in terms of its output current, depending on the amount of radiation light. From the viewpoint of a power circuit having the Si-PM connected thereto, the Si-PM is an element having a large load fluctuation.

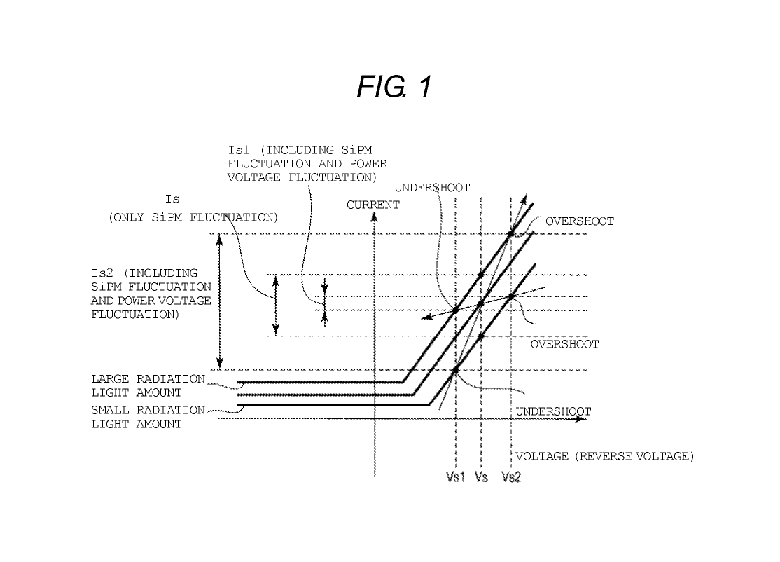

FIG. 1 illustrates a relationship between the voltage and the current applied to a Si photodiode for different amounts of radiation light. When the power supply voltage supplied to the Si photodiode is stable (as indicated by Vs), the Si photodiode outputs a current Is depending on the radiation light amount without being affected by a fluctuation of the power supply voltage.

When the power supply voltage supplied to the Si photodiode includes undershoot or overshoot and the power supply voltage fluctuates in the range from Vs1 to Vs2 in FIG. 1, the output current of the Si photodiode reflects a current change according to the radiation light amount and a current change according to the fluctuation of the power supply voltage. For example, when the voltage changes from Vs2 to Vs1 while the radiation light amount changes from small to large, the output current of the Si photodiode changes by a small amount, as indicated by Is1. However, it is difficult to determine whether the fluctuation is caused by change of the radiation light amount or change of the voltage. Also, when the voltage changes from Vs1 to Vs2 while the radiation light amount changes from small to large, the output current of the Si photodiode changes by a large amount, as indicated by Is2. In this case, it is also difficult to determine whether the fluctuation is caused by change of the radiation light amount or change of the voltage. Accordingly, when a fluctuation of the power supply voltage is large, the amount of radiation light may not be precisely detected.

### First Embodiment

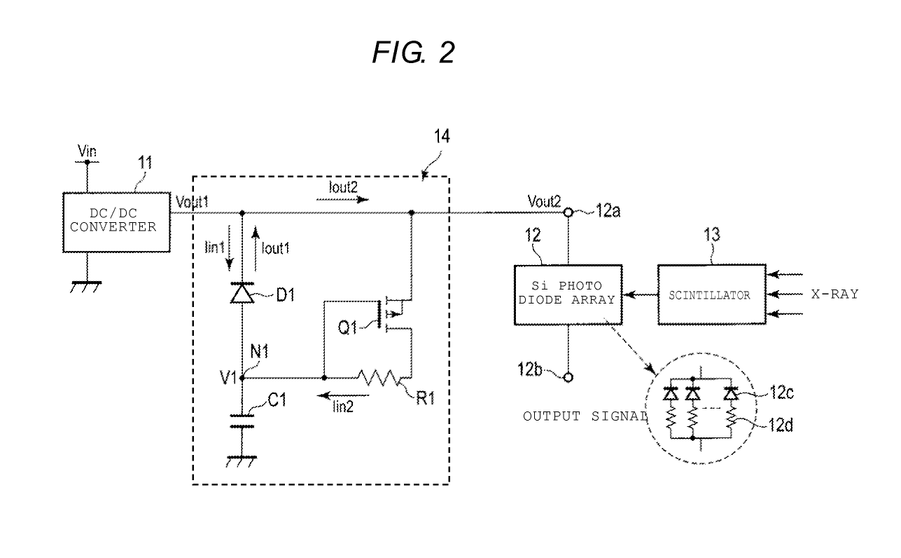

FIG. 2 illustrates an example of an X-ray detector having a power supply stabilizing circuit for Si photodiode arrays, according to a first embodiment.

A DC/DC converter 11 generates a direct current voltage Vout1 of, for example, 50 V from a direct current power source Vin and supplies the voltage Vout1 from an output end. The output end of the DC/DC converter 11 is connected to a power supply terminal 12a of a Si photodiode array 12. The Si photodiode array 12 includes a plurality of Si photodiodes 12c and a plurality of resistors 12d, and series connections of the Si photodiode 12c and the resistor 12d are disposed in an arrayed shape. The Si photodiode 12c is operated in Geiger mode in order to detect the photons radiated from a scintillator 13. The detection signal of the Si photodiode array 12 is output from the output terminal 12b.

A power supply stabilizing circuit 14 is connected to the output end of the DC/DC converter 11. This power supply stabilizing circuit 14 includes, for example, a Schottky barrier diode (hereinafter, referred to as Schottky diode) D1, a capacitor C1, a P-channel MOS transistor (hereinafter, referred to as a PMOS transistor) Q1, and a resistor R1.

The Schottky diode D1 and the capacitor C1 are connected in series between the output end of the DC/DC converter 11 and ground. In other words, the cathode of the Schottky diode D1 is connected to the output end of the DC/DC converter 11, the anode of Schottky diode 11 is connected to one electrode of the capacitor C1, and the other electrode of the capacitor C1 is grounded.

A connection node N1 of the Schottky diode D1 and the capacitor C1 is connected to a gate electrode of the PMOS transistor Q1. A source of the PMOS transistor Q1 is connected to the output end of the DC/DC converter 11, and a drain of the PMOS transistor Q1 is connected to the connection node N1 of the Schottky diode D1 and the capacitor C1 through resistor R1.

### Description of Operation

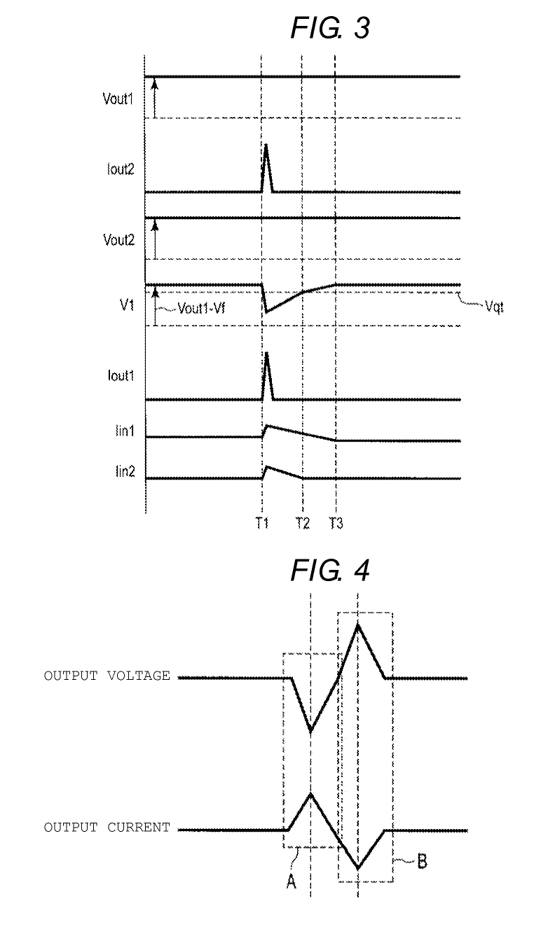

An operation of the power supply stabilizing circuit 14 illustrated in FIG. 2 will be described with reference to FIG. 3.

As illustrated in FIG. 3, the DC/DC converter 11 is in an activated state and a voltage Vout1 is supplied from the output end of the DC/DC converter 11. The voltage Vout1 is supplied to the power supply terminal 12a of the Si photodiode array 12 as a voltage Vout2. In a stationary state, where the Si photodiode array 12 is not radiated with photon, a current Iout2 does not flow from the output end of the DC/DC converter 11 to the power supply terminal 12a. Thus, in the stationary state, the voltage Vout1 and the voltage Vout2 are equal. When the load of the Si photodiode array 12 varies, the voltage Vout2 varies first and then the voltage Vout1 varies. Therefore, change of the voltage Vout1 and change of the voltage Vout2 have a time lag.

Further, the capacitor C1 is charged in the stationary state, and the voltage of a connection node N1 between the Schottky diode D1 and the capacitor C1 is V1. This voltage V1 satisfies V1=Vout1−Vf (Vf indicates a forward voltage drop). Since the Vf of the Schottky diode D1 is smaller than that of the PN junction diode, the voltage V1 is substantially equal to Vout1 (Vout2). In the stationary state, the Schottky diode D1 is in a non-conductive state, with no flow of currents Iout1 and Iin1.

Further, since the voltage V1 of the connection node N1 is higher than a threshold voltage Vqt of the PMOS transistor Q1, the PMOS transistor Q1 is in an OFF state. Therefore, current Iin2 does not flow into the resistor R1.

In the above state, at a time T1, when the Si photodiode array 12 is radiated with light and the load is increased, the voltage Vout2 and the output current Iout2 of the power supply terminal 12a of the Si photodiode array 12 are urged to decrease. In this state, if there is no power supply stabilizing circuit 14 according to the embodiment, the DC/DC converter 11 would perform a stabilizing operation to increase the output current and the output voltage according to the decrease of the output voltage Vout2 (Vout1).

By contrast, in the embodiment, when the load of the Si photodiode array 12 is increased, the Schottky diode D1 becomes conductive before the DC/DC converter 11 executes the stabilizing operation. In other words, when the Vout2 becomes lower than the Vout1−Vf, the Schottky diode D1 becomes conductive, and the electric charges of the capacitor C1 are added to the output current of the DC/DC converter 11 through the Schottky diode D1, as current Iout1. The Schottky diode D1 has a lower forward voltage drop Vf than the PN junction diode, as mentioned above, and a faster switching speed. Therefore, the Schottky diode D1 instantly becomes conductive in response to a drop of the voltage Vout2, and is able to supply the current Iout1. Accordingly, the output current Iout2 to the Si photodiode array 12 is instantly increased, as illustrated in FIG. 3, and the voltage Vout2 is kept stable without any fluctuation.

As mentioned above, when the load of the Si photodiode array 12 is increased and the voltage Vout2 and the output current Iout2 of the power supply terminal 12a of the Si photodiode array 12 begin to decrease, the Schottky diode D1 supplements the output current Iout2 to the Si photodiode array 12 by adding the current Iout1 at a high speed. Therefore, as illustrated in FIG. 3, the output voltage Vout2 does not vary.

As mentioned above, when the current Iout1 flows from the capacitor C1 through the Schottky diode D1 and the voltage V1 of the connection node N1 becomes lower than the threshold voltage Vqt of the PMOS transistor Q1, the PMOS transistor Q1 switches to an ON state. When this occurs, the current Iin2 flows through the PMOS transistor Q1 and the resistor R1 to charge the capacitor C1. At this point, since the voltage (voltage V1) of the anode of the Schottky diode D1 becomes lower than the voltage (output voltage Vout1 (or Vout2)) of the cathode, a reverse leak current Iin1 flows from the DC/DC converter 11 through the Schottky diode D1, to charge the capacitor C1. In other words, the capacitor C1 is charged according to the current Iin1 and Iin2 at a high speed.

Then, at a time T2, when the voltage V1 of the connection node N1 becomes higher than the threshold voltage Vqt of the PMOS transistor Q1, the PMOS transistor Q1 turns into an OFF state. Therefore, the current Iin2 flowing through the PMOS transistor Q1 and the resistor R1 is shut down, and the capacitor C1 is gradually charged according to the reverse leak current Iin1 from the Schottky diode D1. As a result, an overshoot of the output voltage Vout2 is prevented.

At a time T3, when the voltage V1 of the connection node N1 becomes equal to Vout1−Vf or, in other words, when the voltage V1 gets substantially equal to the output voltage Vout1 (Vout2), the reverse leak current Iin1 of the Schottky diode D1 is shut down, and charging of the capacitor C1 according to the reverse leak current Iin1 is stopped.

The same operation as set forth above is also performed at a staring time of the DC/DC converter 11. In an initial state, where the DC/DC converter 11 starts and the voltage Vout1 (Vout2) is supplied from the output end of the DC/DC converter 11, the capacitor C1 is not charged. Therefore, the voltage V1 of the connection node N1 of the Schottky diode D1 and the capacitor C1 is at a low level. The PMOS transistor Q1 is in an ON state and the capacitor C1 is charged according to the current Iin2 flowing through the PMOS transistor Q1 and the resistor R1. Here, the capacitor C1 is also charged according to the reverse leak current Iin1 of the Schottky diode D1. Therefore, the capacitor C1 is charged according to the current Iin1 and Iin2 at a high speed. Then, when the voltage V1 of the connection node N1 becomes higher than the threshold voltage Vqt of the PMOS transistor Q1, the PMOS transistor Q1 switches to the OFF state. Therefore, the current Iin2 becomes shut down, and the capacitor C1 becomes gradually charged according to the reverse leak current Iin1 of the Schottky diode D1. When the voltage V1 of the connection node N1 reaches the output voltage Vout1−Vf, the reverse leak current Iin1 of the Schottky diode D1 is shut down and the charge of the capacitor C1 is stopped.

According to the first embodiment, when the load of the Si photodiode array 12 becomes larger, the current Iout1 is supplied at a high speed from the capacitor C1 through the Schottky diode D1 and added to the output current Iout2 to the Si photodiode array 12, prior to the stabilizing operation of the DC/DC converter 11. This may suppress a fluctuation of the voltage Vout2 at the power supply terminal 12a of the Si photodiode array 12, and hence prevents an overshoot and an undershoot of the voltage Vout2. As a result, the detection precision of the Si photodiode array 12 is improved.

In other words, the Si photodiode array 12 operates at an extremely high speed (on the order of 10 ns or less). Further, the power supply voltage is a high voltage (for example, 50 V). Therefore, in response to a fast load fluctuation, it is difficult for a general DC/DC converter to stabilize the power supply voltage of 50 V according to the feedback control. According to the power supply stabilizing circuit 14 of the first embodiment, however, the power supply voltage may be stabilized by following the operation of the Si photodiode array 12 at a high speed. Accordingly, detection precision of the Si photodiode array 12 is improved.

FIG. 4 illustrates one example of the operation of a general DC/DC converter which is not coupled with the power supply stabilizing circuit 14 of the first embodiment. When the output voltage fluctuates according to a load fluctuation, the DC/DC converter operates so that the output voltage maintains a constant value. As indicated by A in FIG. 4, for example, when the load increases and the output voltage of the DC/DC converter decreases, the DC/DC converter operates so that the output current is increased according to the decrease of the output voltage. Generally, in the DC/DC converter, since change of the output current is faster than a fluctuation of the output voltage, the output voltage of the DC/DC converter increases according to the change of the output current. However, the output voltage cannot follow the decrease of the output current and overshoots, as indicated by B in FIG. 4. In order to suppress this, the DC/DC converter operates so as to reduce the output current. According to this, the general DC/DC converter causes an overshoot and an undershoot of the output voltage according to the stabilizing operation of the output voltage.

As mentioned above, according to the first embodiment, the power supply stabilizing circuit 14 stabilizes the output voltage Vout2 prior to the stabilizing operation by the DC/DC converter 11, thereby preventing the overshoot and the undershoot of the output voltage Vout2.

Further, according to the first embodiment, when the electric charge of the capacitor C1 is reduced, the capacitor C1 can be charged at a highspeed according to the current Iin2 flowing through the PMOS transistor Q1 and the resistor R1 and the reverse leak current Iin1 of the Schottky diode D1. When the capacitor C1 is fully charged and the voltage V1 of the connection node N1 exceeds the threshold voltage Vqt of the PMOS transistor Q1, the capacitor C1 is gradually charged according to only the reverse leak current Iin1 of the Schottky diode D1. Therefore, an overshoot of the output voltage Vout2 can be prevented.

### Second Embodiment

FIG. 5 illustrates a power supply stabilizing circuit and a Si-PM, according to a second embodiment. In the second embodiment, the same reference codes are attached to the same components as those depicted for the first embodiment.

In the first embodiment, it is assumed that a load fluctuation of the Si photodiode array 12 (which is the load of the DC/DC converter 11) is fast, and the power supply stabilizing circuit 14 includes the PMOS transistor Q1 and the resistor R1 in order to charge the capacitor C1 at a high speed.

In the second embodiment, it is assumed that the load fluctuation of the Si photodiode array 12 is more gradual compared to the first embodiment. In this case, the capacitor C1 may afford a sufficient charging time. Therefore, the power supply stabilizing circuit 14 is formed by the Schottky diode D1 and the capacitor C1, and the capacitor C1 is gradually charged according to the reverse leak current of the Schottky diode D1.

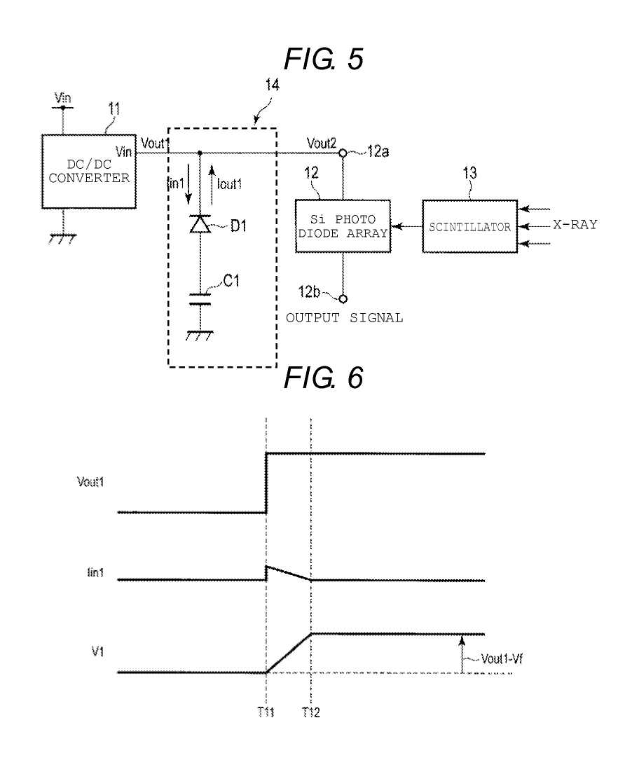

FIG. 6 illustrates an example of the charging operation of the capacitor C1 when the DC/DC converter 11 is turned on. Before the DC/DC converter 11 is turned on, the voltage V1 of the connection node N1 of the Schottky diode D1 and the capacitor C1 is 0 V because the capacitor C1 is not charged.

At a time T11, when the DC/DC converter 11 starts, the output signal Vout1 is supplied from the output end of the DC/DC converter 11. Here, since the Schottky diode D1 is in a reverse bias state, the reverse leak current Iin1 flows in the Schottky diode D1 to charge the capacitor C1. The voltage V1 of the connection node N1 increases according to the charge of the capacitor C1. At a time T12, when the voltage V1 becomes Vout1−Vf (i.e., when the voltage V1 becomes substantially equal to the output voltage Vout1), the reverse leak current Iin1 of the Schottky diode D1 is shut down and the charge of the capacitor C1 is completed.

In the above state, the supply operation of the current Iout1 by the Schottky diode D1 when the load of the Si photodiode array 12 is increased is the same as that of the first embodiment.

When the current Iout1 by the Schottky diode D1 is supplied to the output current Iout2 to the Si photodiode array 12, the voltage V1 of the connection node N1 of the Schottky diode D1 and the capacitor C1 becomes less than Vout1−Vf. Therefore, the reverse leak current Iin1 flows to the Schottky diode D1 and the capacitor C1 is gradually charged according to this reverse leak current Iin1.

According to the second embodiment, where the load fluctuation of the Si photodiode array 12 is more gradual than in the first embodiment, the voltage of the power supply terminal 12a of the Si photodiode array 12 may sufficiently be stabilized, in a similar manner as the first embodiment. Therefore, the detection precision of the Si photodiode array 12 may be improved.

Further, in the case of the second embodiment, since the power supply stabilizing circuit 14 may be formed by the Schottky diode D1 and the capacitor C1, the structure of the second embodiment is simpler than the structure of the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply stabilizing circuit comprising:
a diode having a cathode connected to an output terminal of a direct current power circuit configured to generate a direct current voltage and to supply the voltage therefrom to a load circuit; and
a capacitor connected to an anode of the diode.

2. The power supply stabilizing circuit according to claim 1, wherein
the diode is a Schottky diode.

3. The power supply stabilizing circuit according to claim 1, wherein
the load circuit is a photodiode array.

4. The power supply stabilizing circuit according to claim 3, wherein the photodiode array includes a plurality of circuit units connected in parallel, each circuit unit including a Si photodiode and a resistor connected in series.

5. The power supply stabilizing circuit according to claim 4, wherein each of the Si photodiodes converts photons from a scintillator into photoelectrons.

6. The power supply stabilizing circuit according to claim 1, wherein a terminal of the capacitor that is opposite to a terminal connected to the anode of the diode is connected to ground potential.

7. A power supply stabilizing circuit comprising:
a diode having a cathode connected to an output terminal of a direct current power circuit configured to generate a direct current voltage and to supply the voltage therefrom to a load circuit;
a capacitor connected to an anode of the diode; and
a transistor having a first terminal connected to the output terminal of the direct current power circuit, a second terminal connected to a connection node between the diode and the capacitor, and a switching electrode connected to the connection node.

8. The power supply stabilizing circuit according to claim 7, wherein the transistor is a P-channel MOS (PMOS) transistor.

9. The power supply stabilizing circuit according to claim 8, further comprising:
a resistor connected between a drain of the PMOS transistor and the connection node.

10. The power supply stabilizing circuit according to claim 7, wherein the diode is a Schottky diode.

11. The power supply stabilizing circuit according to claim 7, wherein the load circuit is a photodiode array.

12. The power supply stabilizing circuit according to claim 11, wherein the photodiode array includes a plurality of circuit units connected in parallel, each circuit unit including a Si photodiode and a resistor connected in series.

13. The power supply stabilizing circuit according to claim 12, wherein each of the Si photodiodes converts photons from a scintillator into photoelectrons.

14. The power supply stabilizing circuit according to claim 1, wherein a terminal of the capacitor that is opposite to a terminal connected to the anode of the diode is connected to ground potential.

15. A photodetector comprising:
a photodiode array including one or more Si photodiodes;
a direct current power circuit configured to generate a direct current voltage and supply the voltage to the photodiode array;
a diode having a cathode connected to an output terminal of the direct current power circuit; and
a capacitor connected to an anode of the diode.

16. The photodetector according to claim 15, further comprising:
a transistor having a first terminal connected to the output terminal of the direct current power circuit, a second terminal connected to a connection node between the diode and the capacitor, and a switching electrode connected to the connection node.

17. The photodetector according to claim 16, wherein
the direct current power circuit is a DC to DC converter.

18. The photodetector according to claim 17, wherein
the diode is a Schottky diode.

19. The photodetector according to claim 18, wherein, when a voltage at the connection node is lower than the voltage generated by the direct current power circuit, the Schottky diode is configured to conduct a reverse leak current from the direct current power circuit so that the capacitor is charged.

20. The photodetector according to claim 19, wherein when the voltage at the connection node is lower than a threshold voltage of the transistor, the transistor is configured to conduct a current between the first and second terminals so that the capacitor is charged.
